(19) United States
(12) Patent Application Publication
(10) Pub. No.: US 2008/0020238 A1
(43) Pub. Date: Jan. 24, 2008

(54) Magentic Disk and Glass Substrate for Magnetic Disk

(76) Inventors: Hirotaka Tanaka, Tokyo (JP); Tsuyoshi Ozawa, Tokyo (JP); Masao Takano, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 11/547,010

(22) PCT Filed: Mar. 29, 2005
(86) PCT No.: PCT/JP05/05896

§ 371 Date: Jul. 17, 2007

(30) Foreign Application Priority Data
Mar. 31, 2004 (JP) 2004-104081

(51) Int. Cl. G11B 5/33; B32B 9/00; G11B 5/706

(52) U.S. Cl. 428/810; 428/141; 428/848

(57) ABSTRACT

An anisotropic texture is formed on a principal surface in the circumferential direction of the principal surface. The circumferential roughness of the principal surface increases from an outer circumferential section toward an inner circumferential section of the principal surface. The ratio [Ra-c/Ra-r] of the circumferential roughness (Ra-c) to the radial roughness (Ra-r) of the principal surface increases from the outer circumferential section toward the inner circumferential section.

### TECHNICAL FIELD

The present invention relates to a magnetic disk for use in a hard disk drive (HDD) as a magnetic disk device, and also relates to a glass substrate for such a magnetic disk.

### BACKGROUND ART

Recently, the development of the IT industry is promoting remarkable technological innovation in data storage technology and particularly in magnetic recording technology. Magnetic disks, unlike magnetic recording media such as magnetic tapes and flexible disks, are being rapidly enhanced in data storage density. The magnetic disks are installed in hard disk drives (HDDs) as magnetic disk apparatuses used as storages for computers. The amount of data that can be stored in a personal computer is being remarkably increased with an increase in data storage density.

A magnetic disk for such use includes a substrate made of an aluminum alloy and a magnetic layer disposed thereon. In a hard disk drive, a magnetic head flies over the magnetic disk rotating at high speed. The magnetic head records data signals on the magnetic layer in the form of magnetic pattern or reproduces such data signals.

The magnetic disk needs to have excellent magnetic properties in the flight direction of the magnetic head. Japanese Unexamined Patent Application Publication (JP-A) No. 2002-30275 discloses a technique for increasing storage density. In the technique, a principal surface of a substrate for a magnetic disk is concentrically textured such that the magnetic disk has anisotropic magnetic properties in the circumferential direction thereof and serves as a magnetic recording medium having superior magnetic properties.

In recent years, applications (so-called “mobile applications”) such as portable apparatuses (so-called “notebook personal computers”) including hard disk drives have been demanded. Following this, as magnetic disk substrates, use is made glass substrates having high strength, toughness, and impact resistance. The glass substrates can be readily processed so as to have smooth surfaces and is therefore suitable for reducing the flying height of magnetic heads that fly over the magnetic disks to record or reproduce data. Therefore, magnetic disks having high data storage density can be manufactured using the glass substrates. That is, the glass substrates can cope with the reduction in the flying height of the magnetic heads.

Japanese Unexamined Patent Application Publication (JP-A) No. 2002-32909 discloses a technique for processing a glass substrate for manufacturing a magnetic disk for such use. In this technique, a principal surface of the glass substrate is concentrically textured such that the magnetic disk has excellent magnetic properties, excellent recording and reproducing properties, and high data-recording density.

On the other hand, in order to increase the data storage capacity of magnetic disks, the area of a useless region of each magnetic disk needs to be reduced because no data signals are recorded in the region. A CSS system (a contact start/stop system) conventionally used to start and stop hard disk drives is being replaced by an LUL system (a load/unload system, otherwise a ramp loading system) suitable for increasing data storage capacity.

In the CSS system, a magnetic disk needs to have a CSS zone on which a magnetic head is placed during the non-operation (stop) of the magnetic disk.

In the LUL system, a magnetic head is moved toward an outer section of a magnetic disk, separated from the magnetic disk, and then supported upon the non-operation (stop) of the magnetic disk. That is, the LUL system differs from the CSS system in that the magnetic head is kept away from the magnetic disk and the magnetic disk need not have any irregularities for preventing sticking although the CSS zone has such irregularities. Therefore, in the LUL system, a principal surface of the magnetic disk may be extremely smooth.

Magnetic disks for the LUL system are superior to magnetic disks for the CSS system in that data storage density can be increased because the flying height of magnetic heads can be reduced and the S/N ratio (the signal to noise ratio) of recording signals can be increased.

Since the use of the LUL system causes a reduction in the flying height of the magnetic heads, the magnetic heads need to operate stably at an extremely small flying height of 10 nm or less. The flight of the magnetic heads over the magnetic disks at such an extremely small flying height frequently causes fly stiction.

Fly stiction is a defect that the flying behavior and height of a magnetic head flying over a magnetic disk are changed so that irregular fluctuations in reproduction output causes to occur. The occurrence of such fly stiction can cause the flying magnetic head to be brought into contact with the magnetic disk, resulting in head crush.

In conventional hard disk drives, the following attempts have been made to prevent the occurrence of fly stiction: an attempt to increase the relative linear velocity between a magnetic head and a magnetic disk by increasing the rotational speed of the magnetic head and an attempt to stabilize the flight of the magnetic head by improving the configuration of the magnetic head.

Patent Document 1: Japanese Unexamined Patent Application Publication (JP-A) No. 2002-30275

Patent Document 2: Japanese Unexamined Patent Application Publication (JP-A) No. 2002-32909

### DISCLOSURE OF INVENTION

### PROBLEMS TO BE SOLVED BY INVENTION

In recent years, since the spacing loss between a magnetic disk and a magnetic head has been reduced and the S/N ratio of a recording signal has been increased, the data storage density of the magnetic disk has been increased to greater than 40 gigabit per square inch. Furthermore, attempts are being made to achieve an exceptionally high data storage density of greater than 100 gigabit per square inch.

Since recent magnetic disks have such high data storage density, the recent magnetic disks have an advantage that the recent magnetic disks can store a sufficient amount of data for practical use although the recent magnetic disks have areas considerably less than those of conventional magnetic disks. Furthermore, the recent magnetic disks have advantages that the data-recording speeds and data-reproducing speeds (response speeds) of the recent magnetic disks are extremely greater than those of other data storage media and data can be recorded on or reproduced from the recent magnetic disks as required.

Since the above advantages of the recent magnetic disks have attracted much attention, the following drives have been recently demanded: compact hard disk drives that can be installed in apparatuses such as mobile phones, digital cameras, portable digital apparatuses (for example, PDAs (personal digital assistants)), and car navigation systems, the apparatuses including housings considerably smaller than personal computers and being capable of operating at high response speeds. In particular, there is demand for a compact hard disk drive including a magnetic disk manufactured from a substrate having an outer diameter of 50 mm or less and a thickness of 0.5 mm or less.

The outer circumference and inner circumference of the magnetic disk, used for the compact hard disk drive, having an outer diameter of 50 mm or less are both small. As a consequence, the relative linear velocity between the magnetic disk and a magnetic head is low. Furthermore, as the magnetic disk is reduced in diameter, a spindle motor for rotating the magnetic disk also has a small size. Consequently, it is difficult to increase the rotational speed of the magnetic disk. Therefore, fluctuations in flying behavior and flying height and the fly stiction described above may not be sufficiently prevented.

Since the magnetic disk has such a small outer diameter, the magnetic head also has a small size. This leads to a reduction in the flying stability of the magnetic disk.

The present invention has been made in view of the above circumstances. It is a first object of the present invention to provide a magnetic disk and a glass substrate useful in manufacturing the magnetic disk. The magnetic disk is effective in preventing the occurrence of fly stiction although the magnetic disk has a small diameter such that the magnetic disk can be used for compact hard disk drives that can be installed in extremely portable apparatuses such as mobile phones, digital cameras, portable “MP3 players”, portable digital apparatuses such as PDAs, and vehicle-mounted apparatuses such as car navigation systems.

For a small-diameter magnetic disk (a 1-or 0.85-inch magnetic disk), the relative linear velocity between an ID side of the magnetic disk and a magnetic head is small as described above. Therefore, the magnetic head readily falls on the magnetic disk. This phenomenon occurs particularly under low-pressure conditions. Therefore, in order to evaluate improvements in flying properties of magnetic heads, TDP (touch-down pressure) and TOP (take-off pressure) are measured.

There are demands to use portable apparatuses (mobile phones, digital cameras, digital video cameras, portable music players, PDAs, and the like) including the above magnetic disk devices during mountaineering or in circumstances, such as airplanes, in which the pressure varies because of the portability of the apparatuses. The variation in the pressure in such circumstances affects the pressure in the magnetic disk devices. This often causes magnetic heads to fall on magnetic disks. Therefore, it is necessary to improve TDP (touch-down pressure), TOP (take-off pressure), and the difference ΔP therebetween.

In view of the above problems, it is a second object of the present invention to provide a magnetic disk and a glass substrate for the magnetic disk which is useful in enhancing flying properties by improving TOP.

### MEANS FOR SOLVING THE PROBLEMS

The inventors have performed investigation to achieve the first object and then found that the above problems can be solved as described below. A principal surface of a glass substrate for a magnetic disk is treated so as to have a texture (hereinafter referred to as “an anisotropic texture”), for example, a streaky texture, which has irregularities arranged anisotropically and which has components, crossing each other, extending in the circumferential direction of the glass substrate. The circumferential roughness of the principal surface increases from an outer circumferential section toward an inner circumferential section of the glass substrate. The anisotropic texture has a function of imparting magnetic anisotropy to a magnetic layer disposed on the principal surface and allows the magnetic head to fly stably over the inner circumferential section.

The inventors have also found that the increase in the angle (crossing angle) between the crossing texture components from the outer circumferential section toward the inner circumferential section allows the anisotropic texture to have a function of imparting magnetic anisotropy to the magnetic layer and also allows the magnetic head to fly stably over the inner circumferential section, thereby solving the above problems.

Furthermore, the inventors have performed investigation to achieve the second object as well as the first object and then found that the surface roughness of the substrate is the key to solve the above problems. Specifically, since the surface roughness of the magnetic disk depends on the surface roughness of the substrate that does not have a magnetic recording layer yet, the surface roughness of the magnetic disk can be controlled by controlling the surface roughness of the substrate. The inventors have found that TOP can be controlled in such a manner that the magnetic disk is treated so that the inner and outer circumferential sections of the principal surface are different in roughness from each other.

Specifically, the substrate is processed such that an ID side of the substrate has a large surface roughness so that an ID side of the magnetic disk is allowed to have a large surface roughness. The surface roughness of the substrate increases continuously or stepwise from an OD side toward the ID side of the substrate. Therefore, the surface roughness of the magnetic disk, which is prepared by forming the magnetic layer on the substrate, increases continuously or stepwise from the OD side toward the ID side.

Since the anisotropic texture is formed on the principal surface of the glass substrate in the circumferential direction of the glass substrate, the anisotropic texture aligns the magnetic anisotropy (magnetic easy axis) of the magnetic layer in the circumferential direction of the glass substrate when the magnetic layer is formed on the glass substrate. The anisotropic texture can be formed by, for example, mechanical polishing (referred to as mechanical texturing in some cases).

The present invention is as described below.

(Structure 1)

According to the present invention, there is provided a glass substrate for a magnetic disk installed in a hard disk drive, wherein:

a circumferential roughness on a principal surface in a circumferential direction of the glass substrate increases from an outer circumferential section toward an inner circumferential section of the principal surface.

(Structure 2)

According to the present invention, the glass substrate according to Structure 1, wherein:

the circumferential roughness of the principal surface increases continuously from the outer circumferential section toward the inner circumferential section.

(Structure 3)

According to the present invention, the glass substrate according to Structure 1, wherein:

the principal surface has a region which is located at a radius of 6 mm from a center of the glass substrate and which has a circumferential arithmetic average roughness of 0.25 nm or more, and

the principal surface has a region which is located at a radius of 11 mm from the center of the glass substrate and which has a circumferential arithmetic average roughness of 0.24 nm or less.

(Structure 4)

According to the present invention, the glass substrate according to Structure 1, wherein:

the ratio of the circumferential roughness to a radial roughness of the principal surface in a radical direction increases from the outer circumferential section toward the inner circumferential section.

(Structure 5)

According to the present invention, the glass substrate according to Structure 1, wherein:

a ratio of a circumferential arithmetic average roughness to a radial arithmetic average roughness of a region of the principal surface which is located at a radius of 6 mm from a center of the glass substrate is 0.61 or more, and

a ratio of the circumferential arithmetic average roughness to the radial arithmetic average roughness of a region of the principal surface which is located at a radius of 11 mm from the center of the glass substrate is 0.60 or less.

(Structure 6)

According to the present invention, there is provided a glass substrate for a magnetic disk installed in a hard disk drive, wherein:

a principal surface has a texture including components crossing each other and extending in a circumferential direction of the glass substrate, and a crossing angle between the texture components increases from an outer circumferential section toward an inner circumferential section of the principal surface.

(Structure 7)

According to the present invention, the glass substrate according to Structure 6, wherein:

the crossing angle between the texture components increases continuously from the outer circumferential section toward the inner circumferential section.

(Structure 8)

According to the present invention, the glass substrate according to Structure 6, wherein:

the crossing angle between the texture components present in a region of the principal surface which is located at a radius of 6 mm from a center of the glass substrate is 5.0 degrees or more, and

the crossing angle between the texture components present in a region of the principal surface which is located at a radius of 11 mm from the center of the glass substrate is 4.5 degrees or less.

(Structure 9)

According to the present invention, the glass substrate according to Structure 1 or 6, wherein:

the principal surface is processed so as to have a magnetic layer formed thereon, whereby the glass substrate is converted into the magnetic disk, and

the texture of the principal surface imparts magnetic anisotropy to the magnetic layer.

(Structure 10)

According to the present invention, the glass substrate according to Structure 1 or 6, wherein:

the magnetic disk is installed in a 1-inch hard disk drive or a hard disk drive smaller than such a 1 -inch hard disk drive.

(Structure 11)

According to the present invention, the glass substrate according to Structure 1 or 6, wherein:

the magnetic disk is installed in a hard disk drive which is started and stopped by a load/unload system.

(Structure 12)

According to the present invention, a disk-shaped glass substrate for a magnetic disk, comprises:

a principal surface having a first region and a second region with a roughness greater than that of the first region,

wherein the first region is located outside the second region.

(Structure 13)

According to the present invention, the glass substrate according to Structure 12, wherein:

the first region is used to guide a magnetic head to the magnetic disk.

(Structure 14)

According to the present invention, a magnetic disk, comprises:

the glass substrate according to any one of Structures 1, 6, and 12, wherein the glass substrate has at least one magnetic layer disposed thereon.

(Structure 15)

According to the present invention, the magnetic disk according to Structure 14, wherein:

the principal surface has a region with a roughness less than the surface roughness of a magnetic head to be used.

The circumferential roughness (Ra-c) of a principal surface of a glass substrate for a magnetic disk is defined as an arithmetic average roughness that is determined in such a manner that a 5-μm square region of the principal surface is observed by atomic force microscopy and scanned with a measuring probe in the circumferential direction of the glass substrate.

The radial roughness (Ra-r) of the principal surface is defined as an arithmetic average roughness that is determined in such a manner that a 5-μm square region of the principal surface is observed by atomic force microscopy and scanned with a measuring probe in the radial direction of the glass substrate.

The roughness (Ra) of the principal surface is defined as an arithmetic average roughness that is determined in such a manner that a 5-μm square region of the principal surface is observed by atomic force microscopy and scanned with a measuring probe in the radial direction of the glass substrate. The arithmetic average roughness is determined according to Japanese Industrial Standard (JIS) B 0601.

Advantages

In a glass substrate for a magnetic disk according to the present invention, the circumferential roughness of a principal surface of the glass substrate increases from an outer circumferential section toward an inner circumferential section of the principal surface. This is effective in imparting magnetic anisotropy to a magnetic layer formed on the principal surface and allows a magnetic head to fly stably over the inner circumferential section.

The principal surface has a region which is located at a radius of 6 mm from the center of the glass substrate and which has a circumferential roughness (Ra-c) of 0.25 nm or more. The principal surface also has a region which is located at a radius of 11 mm from the center of the glass substrate and which has a circumferential roughness (Ra-c) of 0.24 nm or less on an arithmetic average basis. This allows the magnetic head to fly stably over the inner circumferential section.

In the glass substrate, the ratio of the circumferential roughness (Ra-c) to the radial roughness (Ra-r) of the principal surface, that is, the ratio [Ra-c/Ra-r] increases from the outer circumferential section toward the inner circumferential section of the principal surface. This is effective in imparting magnetic anisotropy to the magnetic layer and allows the magnetic head to fly stably over the inner circumferential section.

In the principal surface, the ratio [Ra-c /Ra-r] of the circumferential roughness (Ra-c) to the radial roughness (Ra-r) of the region located at a radius of 6 mm from the substrate center is 0.61 or more and the ratio [Ra-c/Ra-r] of the circumferential roughness (Ra-c) to the radial roughness (Ra-r) of the region located at a radius of 11 mm from the substrate center is 0.60 or less. This allows the magnetic head to fly stably over the inner circumferential section.

The principal surface has a texture having components, crossing each other, extending in the circumferential direction of the glass substrate and the angle (crossing angle) between the crossing texture components increases from the outer circumferential section toward the inner circumferential section. This is effective in imparting magnetic anisotropy to the magnetic layer and allows the magnetic head to fly stably over the inner circumferential section.

The angle between the crossing texture components can be determined readily and precisely in such a manner that a 5-μm square region of the principal surface is measured by atomic force microscopy and the obtained measurements are Fourier-transformed.

In the principal surface, the texture components present in the region located at a radius of 6 mm from the substrate center cross at an angle of 5.0 degrees or more and the texture components present in the region located at a radius of 11 mm from the substrate center cross at an angle of 4.5 degrees or less. This allows the magnetic head to fly stably over the inner circumferential section.

The magnetic disk according to the present invention includes the glass substrate and the magnetic layer disposed thereon. Therefore, if the magnetic disk has a small diameter of, for example, 50 mm or less, the magnetic layer has magnetic anisotropy and the magnetic head can fly stably over the inner circumferential section. Furthermore, the magnetic disk has high load/unload durability. The magnetic disk is suitable for use in hard disk drives started or stopped by an LUL (load/unload) method.

Since the surface roughness of an ID side (inner circumferential section) of the glass substrate is different from that of an OD side (outer circumferential section) thereof, TOP of the ID side is better than those of OD sides of magnetic disks having uniform surface roughness. Therefore, even if the pressure in a hard disk drive including the magnetic disk is reduced to TDP and a magnetic head included in the hard disk drive is thus brought into contact with the magnetic disk, the resulting magnetic head is readily lifted and detached from the magnetic disk because TOP is low.

The present invention provides a magnetic disk and a substrate for manufacturing the magnetic disk. The magnetic disk is suitable for use in a hard disk drive including a magnetic head having good flying properties. The magnetic head hardly falls on the magnetic disk during mountaineering or in circumstances, such as airplanes, in which the pressure varies. Even if the magnetic head falls on the magnetic disk, the resulting magnetic head is readily lifted therefrom.

The present invention provides a magnetic disk, having a small diameter, suitable for use in a compact hard disk drive that can be installed in a highly portable apparatus such as a mobile phone, a digital camera, a portable “MP3 player”, a portable digital apparatuses such as a PDA, and a vehicle-mounted apparatus such as a “car navigation system”. The magnetic head is effective in preventing the occurrence of fly stiction. Furthermore, the present invention provides a glass substrate for manufacturing the magnetic disk.

### BRIEF DESCRIPTION OF THE DRAWINGS

FIG. 1 is a perspective view showing a configuration of a texturing machine, for texturing, used in a process for manufacturing a glass substrate for a magnetic disk according to the present invention.

FIG. 2 is a schematic view showing the relative movement between a glass disk textured in the present invention and abrasive tapes.

FIG. 3 is a graph showing the circumferential arithmetic average roughness (Ra-c) of measured regions of principal surfaces of glass substrates of examples and comparative examples.

FIG. 4 is a graph showing the ratio [Ra-c/Ra-r] of the circumferential arithmetic average roughness (Ra-c) to the radial arithmetic average roughness (Ra-r) of principal surfaces of glass substrates of examples and comparative examples.

FIG. 5 includes images obtained by Fourier-transforming the measurements of regions of a principal surface of a glass substrate of an example, the regions being measured by atomic force microscopy.

FIG. 6 is a graph showing the crossing angle between texture components present in measured regions of principal surfaces of glass substrates of examples and comparative examples.

FIG. 7 is a graph which shows the roughness (Ra) of glass substrates of an example and comparative examples and which shows the roughness of magnetic disks of the example and the comparative examples.

FIG. 8 is a conceptual view sowing a TDP/TOP test.

FIG. 9 is a graph showing the TOP determined at region of principal surfaces of magnetic disks of an example and comparative examples.

### BEST MODE FOR CARRYING OUT THE INVENTION

The best mode for carrying out the present invention will now be described in detail with reference to the accompanying drawings.

A glass substrate for a magnetic disk according to present invention is manufactured by the following procedure: a glass base material is prepared by grinding a principal surface of a sheet glass, a glass disk is prepared by cutting the glass base material, a principal surface of the glass disk is polished, the glass disk is chemically strengthened, and the principal surface of the glass disk is then textured.

Examples of the sheet glass subjected to grinding include sheet glasses having various shapes. The sheet glass may be rectangular or disk-shaped (circular). When the sheet glass is disk-shaped, the sheet glass can be ground with a grinding machine used to manufacture a conventional glass substrate for a magnetic disk. Therefore, the sheet glass can be processed at low cost with high reliability.

The sheet glass needs to have a size greater than that of the glass substrate to be manufactured. In the case where the glass substrate is used to manufacture a magnetic disk installed in, for example, a “1-inch hard disk drive” or a compact hard disk drive smaller than that, the glass substrate needs to have a diameter of about 20 to 30 mm. Therefore, when the sheet glass is disk-shaped, the sheet glass preferably has a diameter of 30 mm or more, more preferably 48 mm or more. In particular, when the sheet glass has a diameter of 65 mm or more, a plurality of glass substrates for manufacturing magnetic disks installed in “1-inch hard disk drives” can be obtained from the single sheet glass. This is suitable for large-scale production. The upper limit of the size of the sheet glass need not be particularly limited. When the sheet glass is disk-shaped, the diameter of the sheet glass is preferably 1 00 mm or less.

The sheet glass can be produced from molten glass by a known process such as a pressing process, a float process, or a fusion process. Among these processes, the pressing process is useful in manufacturing the sheet glass at low cost.

A material for forming the sheet glass is not particularly limited and may be glass that can be chemically strengthened. Such a material is preferably aluminosilicate glass. The aluminosilicate glass preferably contains lithium. If the aluminosilicate glass is chemically strengthened by ion exchange at low temperature, the resulting aluminosilicate glass can be used to precisely form a compressive-stress layer having a preferred compressive stress or a tensile-stress layer having a preferred tensile stress. Therefore, the aluminosilicate glass is a preferred material for forming the glass substrate.

The aluminosilicate glass preferably contains 58 to 75 weight percent SiO₂, 5 to 23 weight percent Al₂O₃, 3 to 10 weight percent Li₂O, and 4 to 13 weight percent Na₂O.

Alternatively, it is preferable that the aluminosilicate glass contain 62 to 75 weight percent SiO₂, 5 to 15 weight percent Al₂O₃, 4 to 10 weight percent Li₂O, 4 to 12 weight percent Na₂O, and 5.5 to 15 weight percent ZrO₂, the weight ratio (Na₂O/ZrO₂) of Na₂O to ZrO₂ range from 0.5 to 2.0, and the weight ratio (Al₂O₃/ZrO₂) of Al₂O₃ to ZrO₂ range from 0.4 to 2.5.

In order to eliminate protrusions caused by undissolved ZrO₂ from the surface of the glass disk, the following glass is preferably used: chemically strengthenable glass containing 57% to 74% SiO₂, 0% to 2.8% ZrO₂, 3% to 15% Al₂O₃, 7% to 16% Li₂O, and 4% to 14% Na₂O on a molar basis.

The aluminosilicate glass chemically strengthened has high flexural strength and Knoop hardness.

Grinding is a process to improve the profile accuracy (for example, the flatness) or dimensional accuracy (for example, the thickness accuracy) of a principal surface of the sheet glass, workpiece, namely, that is, the sheet glass. Grinding is performed in such a manner that a grindstone or a platen is pressed against the principal surface of the sheet glass and the sheet glass and the grindstone or the platen are moved relatively to each other such that the principal surface thereof is ground. The grinding of the principal surface can be performed using a double-ended grinder with a planetary gear train.

Upon grinding, the principal surface of the sheet glass may be fed with a grinding fluid so that sludge (grinding scrap) is washed off from the principal surface and the principal surface is cooled. Alternatively, the principal surface of the workpiece may be fed with slurry containing free abrasive grains in addition to the grinding fluid.

An example of the grindstone used is a diamond grindstone. Examples of the free abrasive grains include hard abrasive grains such as alumina abrasive grains, zirconia abrasive grains, and silicon carbide abrasive grains.

The profile accuracy of the sheet glass is enhanced and the principal surface is planarized by grinding. Thus, the glass base material with a predetermined thickness is obtained.

In the present invention, a principal surface of the glass base material is planarized and the thickness thereof is reduced by grinding. Therefore, the glass disk can be prepared by cutting the glass base material. The occurrence of defects such as chips, cracks, or flows can be prevented when the glass disk is prepared by cutting the glass base material.

The flatness of the glass base material is preferably 30 μm or less and more preferably 10 μm or less, for example, in a 7088 mm² area (the area of a circle with a diameter of 95 mm) of the glass base material. The thickness of the glass base material is preferably 2 mm or less and more preferably 0.8 mm or less. When the thickness of the glass base material is less than 0.2 mm, the glass base material itself may not withstand the stress applied thereto during the cutting of the glass disk. Therefore, the thickness of the glass base material is preferably 0.2 mm or more. When the thickness of the glass base material is greater than 2 mm, the glass base material may not be precisely cut or defects such as chips, cracks, or flows may occur during the cutting of the glass disk.

The glass base material needs to have a size greater than that of the glass substrate to be manufactured. In the case where the glass substrate is used to manufacture a magnetic disk installed in, for example, a “1-inch hard disk drive” or a compact hard disk drive smaller than that, the glass substrate needs to have a diameter of about 20 to 30 mm. Therefore, the glass base material preferably has a diameter of 30 mm or more and more preferably 48 mm or more. In particular, when the glass base material has a diameter of 65 mm or more, a plurality of glass substrates for manufacturing magnetic disks installed in “1-inch hard disk drives” can be obtained from the single glass base material. This is suitable for large-scale production. The upper limit of the size of the glass base material need not be particularly limited. When the glass base material is disk-shape, the diameter of the glass base material is preferably 100 mm or less.

The glass base material can be cut with a grindstone or a cutting tool, such as a diamond cutter or a diamond drill, containing a material harder than glass. Alternatively, the glass base material may be cut with a laser cutter. However, it can be difficult to prepare small-size glass disks having a diameter of 30 mm or less by precisely cutting the glass base material using such a laser cutter. Therefore, the grindstone or the cutting tool is preferably used to cut the glass base material.

The glass disk prepared by cutting the glass base material preferably has a diameter of 30 mm or less.

By the use of a cylindrical grindstone, a circular hole with a predetermined diameter is formed in a center region of the glass disk, the outer end face of the glass disk is ground such that the glass disk has a predetermined diameter, and the outer and inner end faces of the glass disk are then chamfered.

The glass disk prepared from the glass base material is subjected to polishing such that a principal surface of the glass disk is mirror-finished.

Cracks in the principal surface of the glass disk are eliminated by the polishing of the glass disk, so that the principal surface thereof has a roughness of 7 nm or less in Rmax and a roughness of 0.7 nm or less in Ra. If the principal surface thereof is mirror-finished as described above, so-called crash or thermal asperity can be prevented even if a magnetic head flies over the magnetic disk, prepared from the glass disk, at a flying height of, for example, 10 nm. Furthermore, if the principal surface thereof is thus mirror-finished, a fine region of the glass disk can be chemically strengthened uniformly as described below and delayed fracture due to micro-cracks can be prevented.

Rmax represents the maximum height (also represented by Ry) and is equal to the sum (Rp+Rv) of the height (Rp: maximum peak height) of the highest peak above the mean line and the depth (Rv: maximum valley depth) of the deepest valley below the mean line. The maximum height Rmax is determined according to Japan Industrial Standard (JIS) B 0601.

The principal surface of the glass disk is polished in such a manner that a platen having an abrasive pad (abrasive cloth) attached thereto is pressed against the principal surface of the glass disk and the platen and the sheet glass are moved relatively to each other while the principal surface thereof is being fed with an abrasive solution. The abrasive solution preferably contains abrasive grains for polishing. Examples of the abrasive grains include cerium oxide abrasive grains, colloidal silica abrasive grains, and diamond abrasive grains.

Before the glass disk is polished, the glass disk is preferably ground. The glass disk may be ground in the same manner as that for grinding the sheet glass. If the glass disk is ground and then polished, the principal surface thereof can be mirror-finished in a short time.

The outer end face of the glass disk is preferably mirror-polished. Since the outer end face thereof is rough due to cutting, the generation of particles can be prevented by mirror-polishing the outer end face. This is effective in preventing thermal asperity from occurring in the magnetic disk manufactured from the glass substrate.

After the glass disk is polished, the polished glass disk is chemically strengthened. Chemical strengthening can induce a high compressive stress in a surface layer of the glass substrate to enhance the impact resistance thereof. When the glass disk is made of aluminosilicate glass, the glass disk can be chemically strengthened effectively.

A process for chemically strengthening the glass disk is not particularly limited as long as the known the chemical strengthening process is used. The glass disk is chemically strengthened in such a manner that the glass disk is brought into contact with, for example, a heated chemical strengthening salt such that ions in the surface layer of the glass disk are exchanged for ions from the chemical strengthening salt.

Examples of a known ion exchange process include a low-temperature ion exchange process, a high-temperature ion exchange process, a surface crystallization process, and a process for dealkalizing a glass surface. The low-temperature ion exchange process is preferably used herein because ion exchange is performed at a temperature below the annealing point of glass.

The low-temperature ion exchange process refers to a process in which alkali ions in glass are replaced by large alkali ions having an ionic radius greater than that of those alkali ions, a compressive stress is induced in a surface layer of the glass by the increase in the volume of an ion-exchanged portion, and the glass surface layer is thereby strengthened.

In view of effective ion exchange, the temperature of a molten salt used for chemical strengthening is preferably 280° C. to 660° C. and more preferably 300° C. to 400° C.

The time to contact the glass disk with the molten salt is preferably several hours to several ten hours.

Before the glass disk is contacted with the molten salt, the glass disk is preferably preheated at 100° C. to 300° C. The glass disk chemically strengthened is cooled, cleaned, and then subjected to another step. Thus, a product (the glass substrate) is obtained.

A material for forming a treatment bath used for chemical strengthening is not particularly limited and is preferably resistant to corrosion and dust-free. Since the chemical strengthening salt and the molten salt are oxidative and the treating temperature is high, damage and dust need to be prevented by the use of a corrosion-resistant material such that thermal asperity or head crash is avoided. From this point of view, the treatment bath is preferably made of quartz and may be made of a stainless material or a martensitic or austenitic stainless steel having high corrosion resistance. Since quartz is expensive although it has high corrosion resistance, such a material may be selected on an economically feasible basis.

A source material for preparing the chemical strengthening salt preferably contains sodium nitrate and/or potassium nitrate. This is because the chemical strengthening salt is effective in imparting a predetermined toughness and impact resistance to the glass substrate during chemical strengthening when the glass substrate is made of aluminosilicate glass. The principal surface of the glass disk is then textured.

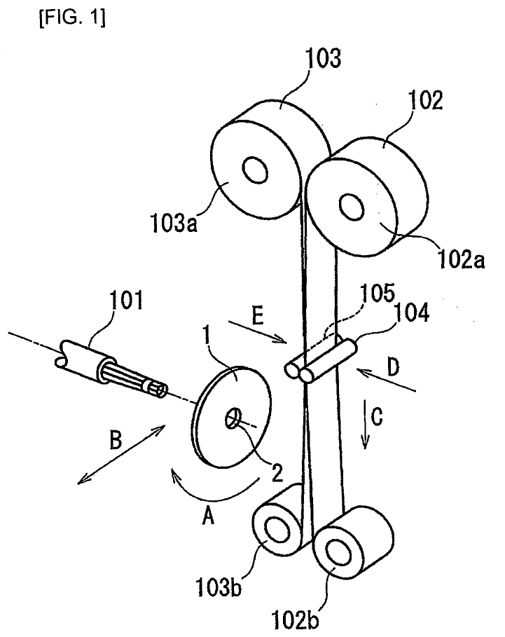

FIG. 1 is a perspective view showing a configuration of a texturing machine, used herein, for texturing.

As shown in FIG. 1, an end portion of a chucking rod 101 included in the texturing machine is fitted into a circular hole 2 located at a center portion of a glass disk 1. Thus, the glass disk 1 is attached to the texturing machine. The end portion of the chucking rod 101 is cylindrical and has a plurality of separated sub-portions extending longitudinally. The end portion thereof can be expanded by applying force to the inside of the end portion. The glass disk is held with the chucking rod 101 in such a manner that the end portion of the chucking rod 101 is fitted into the circular hole 2 of the glass disk 1 and then expanded.

The chucking rod 101 is rotated on its axis at a predetermined speed as indicated by Arrow A shown in FIG. 1 and reciprocated perpendicularly to its axis at a predetermined rate with a predetermined stroke as indicated by Arrow B shown in FIG. 1.

In the texturing machine, a pair of abrasive tapes 102 and 103 are fed from supply rolls 102a and 103a at a predetermined rate as indicated by Arrow C shown in FIG. 1 and then wound around take-up rolls 102b and 103b. The abrasive tapes 102 and 103 are fed in such a manner that the abrasive tapes 102 and 103 overlap one another and the feed rates of the abrasive tapes 102 and 103 are equal to one another.

The glass disk 1 held with the chucking rod 101 are inserted between the moving abrasive tapes 102 and 103 such that principal surfaces of the glass disk 1 are contacted with the abrasive tapes 102 and 103. The abrasive tapes 102 and 103 are pressed against the principal surfaces of the glass disk 1 with a pair of press rollers 104 and 105 with predetermined pressures as indicated by Arrows D and E shown in FIG. 1. Specifically, the principal surfaces of the glass disk 1 are sandwiched between the abrasive tapes 102 and 103.

In this state, the chucking rod 101 is rotated on its axis together with the glass disk 1 and reciprocated perpendicularly to its axis at a predetermined rate with a predetermined stroke. The reciprocation of the chucking rod 101 is perpendicular to the direction in which the abrasive tapes 102 and 103 are fed. A liquid polisher is fed between the glass disk 1 and the abrasive tapes 102 and 103.

The glass disk 1 and the abrasive tapes 102 and 103 are relatively moved in contact with each other.

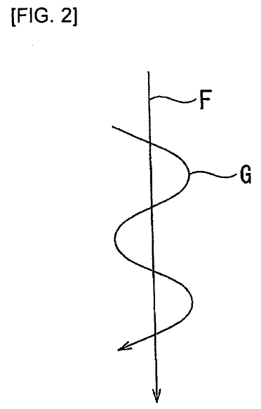

FIG. 2 is a schematic view showing the relative movement between the glass disk and the abrasive tapes.

The feed rate of the abrasive tapes 102 and 103 is extremely small. Therefore, the relative movement between the glass disk 1 and the abrasive tapes 102 and 103 depends on the rotational speed, reciprocating rate, and reciprocating stroke of the glass disk 1. As shown in FIG. 2, the abrasive tapes 102 and 103 are principally moved (Arrow F) relatively to the glass disk 1 in the circumferential direction (tangential direction) of the glass disk 1 and also moved (Arrow G) sinusoidally with respect to the circumferential direction thereof.

The circumferential roughness of the principal surfaces of the textured glass disk 1 is less than the radial roughness thereof. Specifically, textures formed by texturing as described above are “anisotropic” in the circumferential direction of the glass disk 1.

The circumferential roughness of each principal surface of the textured glass disk 1 increases from an outer circumferential section toward an inner circumferential section of the principal surface. Therefore, if a magnetic layer is formed on the principal surfaces, the magnetic layer has magnetic anisotropy and a magnetic head can fly stably over an inner circumferential section of the magnetic layer.

In the principal surface of the glass substrate, a region located at a radius of 6 mm from the center of the glass substrate preferably has a circumferential roughness (Ra-c) of 0.25 nm or more and a region located at a radius of 11 mm from of the center thereof preferably has a circumferential roughness (Ra-r) of 0.24 nm or less on an arithmetic average basis. This allows the magnetic head to fly stably over the inner circumferential section of the principal surface.

In the principal surface of the texture glass disk 1, the ratio of the circumferential roughness (Ra-c) to the radial roughness (Ra-r), that is, the ratio [Ra-c/Ra-r] increases from the outer circumferential section toward the inner circumferential section of the principal surface.

In the principal surface of the glass substrate, the ratio [Ra-c/Ra-r] of the circumferential roughness (Ra-c) to the radial roughness (Ra-r) of the region located at a radius of 6 mm from the substrate center is 0.61 or more and the ratio [Ra-c/Ra-r] of the circumferential roughness (Ra-c) to the radial roughness (Ra-r) of the region located at a radius of 11 mm from the substrate center is 0.60 or less. This allows the magnetic head to fly stably over the inner circumferential section of the principal surface.

The texture formed on the principal surface of the glass disk 1 has components, crossing each other, extending in the circumferential direction of the glass disk 1. The angle (crossing angle) between the crossing texture components increases from the outer circumferential section toward the inner circumferential section of the principal surface of the glass disk 1. This is because, in the principal surface of the glass disk 1, the tangential speed of the inner circumferential section is less than that of the outer circumferential section.

Therefore, the magnetic layer formed on the principal surface of the glass disk 1 has magnetic anisotropy and the magnetic head can fly stably over the inner circumferential section.

The angle between the texture components can be determined readily and precisely in such a manner that a 5-μm square region of the principal surface of the glass disk is measured by atomic force microscopy and the obtained measurements are Fourier-transformed.

In the principal surface of the glass substrate, the texture components present in the region located at a radius of 6 mm from the substrate center preferably cross at an angle of 5.0 degrees or more and the texture components present in the region located at a radius of 11 mm from the substrate center cross at an angle of 4.5 degrees or less. This allows the magnetic head to fly stably over the inner circumferential section of the principal surface.

After the texturing process is finished, the glass disk 1 is cleaned. Thus, the glass substrate is completed.

The glass substrate, manufactured as described above, according to the present invention is suitable for use in a “1-inch hard disk drive” or a compact hard disk drive smaller than the “1-inch hard disk drive”. If the glass substrate is used to manufacture a magnetic disk installed in the “1-inch hard disk drive”, the glass substrate needs to have a diameter of about 27.4 mm. Alternatively, if the glass substrate is used to manufacture a magnetic disk installed in a “0.85-inch hard disk drive”, the glass substrate needs to have a diameter of about 21.6 mm.

In a magnetic disk according to the present invention, the magnetic layer formed on the glass substrate may be made of, for example, a cobalt (Co)-based ferromagnetic material. In particular, the magnetic layer is preferably made of a cobalt-platinum (Co—Pt)-based ferromagnetic material or cobalt-chromium (Co—Cr)-based ferromagnetic material having high coercive force. The magnetic layer can be formed by a DC magnetron sputtering process.

Before the magnetic layer is formed, the glass disk may be circumferentially textured in order to increase magnetic properties of the magnetic layer. A base layer or the like is preferably formed between the glass substrate and the magnetic layer. The base layer may be made of an Al—Ru alloy or a Cr alloy.

A protective layer for protecting the magnetic disk from the impact arising from the magnetic head may be provided on the magnetic layer. A preferred example of the protective layer is a hard protective layer made of carbon hydride.

A lubricating layer made of a PFPE (perfluoropolyether) compound may be provided on the protective layer so that the interference between the magnetic head and the magnetic disk can be reduced. The lubricating layer can be formed by, for example, a dipping process.

### FIRST EXAMPLE

The present invention will now be further described in detail with reference to examples and comparative examples. The present invention is not limited to the examples.

### EXAMPLE 1

### Example of Glass Substrate for Magnetic Disk

In this example, a glass substrate for manufacturing a magnetic disk according to the present invention was manufactured according to Steps (1) to (8) below.

(1) Rough Grinding Step

(2) Shaping Step

(3) Precise Grinding Step

(4) End-face Mirror-polishing Step

(5) Primary Polishing Step

(6) Secondary Polishing Step

(7) Chemical Strengthening Step

(8) Texturing Step

A disk-shaped glass base material made of amorphous aluminosilicate glass was prepared. The aluminosilicate glass contained lithium. The composition of the aluminosilicate glass was as follows: a SiO₂ content of 63.6 weight percent, an Al₂O₃ content of 14.2 weight percent, a Na₂O content of 10.4 weight percent, a Li₂O content of 5.4 weight percent, a ZrO₂ content of 6.0 weight percent, and a Sb₂O₃ content of 0.4 weight percent.

(1) Rough Grinding Step

The aluminosilicate glass was melted and then formed into a sheet glass with a thickness of 0.6 mm. The sheet glass was ground with a grindstone. In this manner, a glass disk having a diameter of 28.7 mm and a thickness of 0.6 mm was prepared.

In order to prepare the sheet glass, a downdraw process or a float process is generally used. A disk-shaped glass base material may be prepared by direct pressing. Aluminosilicate glass used to prepare the sheet glass may contain 58 to 75 weight percent SiO₂, 5 to 23 weight percent Al₂O₃, 4 to 13 weight percent Na₂O, and 3 to 10 weight percent Li₂O.

In order to enhance the dimensional accuracy and profile accuracy of the glass disk, the glass disk was roughly ground with a double-ended grinder using 400-grit abrasive grains.

Specifically, both principal surfaces of the glass disk placed in a carrier were ground using 400-grit alumina abrasive grains in such a manner that the load was set to about 100 kg and a sun gear and internal gears were rotated. The resulting glass disk had a profile irregularity of 0 to 1 μm and a surface roughness (Rmax) of about 6 μm.

(2) Shaping Step

By the use of a cylindrical grindstone, a circular hole with a diameter of 6.1 mm was formed in a center region of the glass disk, the outer end face of the glass disk was ground such that the glass disk had a diameter of 27.43 mm, and the outer and inner end faces of the glass disk were then chamfered. The outer and inner end faces of the glass disk had a surface roughness of about 4 μm in Rmax.

In general, “2.5-inch HDDs (hard disk drives)” use magnetic disks having an outer diameter of 65 mm.

(3) Precise Grinding Step

The principal surfaces of the glass disk were ground using 1000-grit abrasive grains such that the principal surfaces thereof had a roughness of about 2 μm in Rmax and a roughness of about 0.2 μm in Ra.

Since the principal surfaces were precisely ground, fine irregularities formed on the principal surfaces in the rough grinding step or shaping step prior to this step were removed.

The glass disk precisely ground was ultrasonically cleaned in such a manner that the glass disk was placed in a cleaning bath containing a neutral detergent and then in a cleaning bath containing pure water while ultrasonic waves were applied to the cleaning baths.

(4) End-face Mirror-polishing Step

End faces (the outer and inner end faces) of the glass disk were polished with a conventional brush in such a manner that the glass disk was rotated. In this manner, the end faces of the glass disk had a surface roughness of about 1 μm in Rmax and a surface roughness of about 0.3 μm in Ra.

The principal surfaces of the mirror-polished glass disk were cleaned with water.

In this step, the glass disk and similar glass disks are stacked and the end faces of the stacked glass disks are polished. In this case, in order to prevent principal surfaces of the stacked glass disks from being damaged, this step is preferably prior to a primary or secondary polishing step described below or subsequent to the secondary polishing step.

In this step, the end faces of the glass disk were mirror-polished sufficiently to prevent particles or the like from being generated. The resulting glass disk had a diameter of 27.4 mm.

(5) Primary Polishing Step

In order to remove scratches formed and strains created in the precise grinding step, primary polishing was performed using a double-side polishing machine.

In the double-side polishing machine, the glass disk was held with a carrier and tightly fitted between an upper and a lower platen having polishing pads attached thereto, the carrier was engaged with a sun gear and an internal gear, and the upper and lower platens were pressed against the glass disk. The principal surfaces of the glass disk were simultaneously polished in such a manner that the glass disk was rotated on its axis between the platens and also rotated around the internal gear by rotating the sun gear while an abrasive solution was being fed between the polishing pads and the principal surfaces thereof.

A double-side polishing machine similar to that machine was used in an example below. Specifically, primary polishing was performed using hard polishers (rigid urethane foam). Polishing conditions were as follows: the use of an abrasive solution containing cerium oxide grains (an average grain size of 1.3 μm) and RO water, a load of 100 g/cm², and a polishing time of 15 minutes. The primarily polished glass disk was ultrasonically cleaned in such a manner that the glass disk was immersed in a cleaning bath containing a neutral detergent, a cleaning bath containing pure water (1), a cleaning bath containing pure water (2), a cleaning bath containing IPA (isopropyl alcohol), and a cleaning bath containing IPA (vapor drying) in that order. The resulting glass disk was dried.

(6) Secondary Polishing Step

Secondary polishing was performed using soft polishers (suede pads) and a double-side polishing machine similar to that used in the primary polishing step such that the principal surfaces were mirror-finished.

An object of this step is that the flatness of the principal surfaces polished in the primary polishing step is maintained and the roughness Ra of the principal surfaces is reduced to about 0.3 to 0.5 nm.

Polishing conditions were as follows: the use of an abrasive solution containing colloidal silica (an average particle size of 80 nm) and RO water, a load of 100 g/cm², and a polishing time of 5 minutes.

The secondarily polished glass disk was ultrasonically cleaned in such a manner that the glass disk was immersed in a cleaning bath containing a neutral detergent, a cleaning bath containing pure water (1), a cleaning bath containing pure water (2), a cleaning bath containing IPA (isopropyl alcohol), and a cleaning bath containing IPA (vapor drying) in that order. The resulting glass disk was dried.

(7) Chemical Strengthening Step

The cleaned glass disk was chemically strengthened using a chemical strengthening solution containing potassium nitrate and sodium nitrate. The content of lithium eluted from the chemically strengthened glass disk was measured with an ICP emission analyzer.

Chemical strengthening was performed in such a manner that the chemical strengthening solution was heated to 340° C. to 380° C. and the glass disk that had been cleaned and dried were immersed in the heated chemical strengthening solution for about two to four hours. In order to uniformly strengthen the entire surface of the glass disk, the glass disk was immersed therein in such a manner that the glass disk was placed in a holder together with similar glass disks such that end faces of the placed glass disks were held with the holder.

The chemically strengthened glass disk was immersed in a 20° C. water bath for about ten minutes, whereby the glass disk was quenched.

The quenched glass disk was immersed in concentrated sulfuric acid heated to about 40° C. and the glass disk was cleaned. The resulting glass substrate was ultrasonically cleaned in such a manner that the glass substrate was immersed in a cleaning bath containing pure water (1), a cleaning bath containing pure water (2), a cleaning bath containing IPA (isopropyl alcohol), and a cleaning bath containing IPA (vapor drying) in that order. The resulting glass substrate was dried.

The principal surfaces and end faces of the cleaned glass disk were visually inspected and then strictly inspected for optical reflection, scattering, and transmission. The inspection showed that the principal surfaces and end faces of the cleaned glass disk had no protrusions due to deposits or defects such as scratches.

The glass disk treated as described above was measured for surface roughness by atomic force microscopy (AFM). The measurement showed that the principal surfaces of the glass disk had a roughness of 2.5 nm in Rmax and a roughness of 0.30 nm in Ra, that is, the principal surfaces thereof were extremely smooth. The surface roughness was determined in such a manner that surface profile parameters obtained by AFM (atomic force microscopy) were subjected to calculation according to Japanese Industrial Standard (JIS) B 0601.

The glass disk treated as described above had an inner diameter of 7 mm, an outer diameter of 27.4 mm, and a thickness of 0.381 mm, that is, the glass disk had a size suitable for a glass substrate for a magnetic disk used for a “1.0-inch” magnetic disk.

A chamfered region of the inner end face of the glass disk had a surface roughness of 0.4 μm in Rmax and a surface roughness of 0.04 μm in Ra and a wall region of the inner end face thereof had a surface roughness of 0.4 μm in Rmax and a surface roughness of 0.05 μm in Ra. A chamfered region of the outer end face of the glass disk had a surface roughness of 0.04 μm in Ra and a wall region of the outer end face thereof had a surface roughness of 0.07 μm in Ra. Thus, the inner and outer end faces thereof were mirror-finished.

The principal surfaces of the glass disk had no contaminants or particles causing thermal asperity and the inner end faces thereof had no contaminants or cracks.

(8) Texturing Step

The chemically strengthened glass disk was textured using a texturing machine in such a manner that the principal surfaces of the glass disk were sandwiched between abrasive tapes and the glass disk and the abrasive tapes were moved relatively to each other in contact with each other. The abrasive tapes were principally moved relatively to the glass disk in the circumferential direction (tangential direction) of the glass disk and also moved sinusoidally with respect to the circumferential direction thereof.

In this step, a liquid polisher containing diamond abrasive grains was fed between the glass disk and the abrasive tapes.

Texturing conditions used in Example 1 were as summarized in Table 1. Fabric tapes were used as abrasive tapes, polycrystalline diamond slurry was used as a polisher (slurry), the glass disk was rotated at 597 revolutions per minute, the oscillation frequency of the glass disk was 7.8 Hz, the oscillation amplitude of the glass disk was 1 mm, and the processing load applied from pressing rollers was 3.675 kg (1.5 pounds).

TABLE 1

| | Example | Example | Comparative | Comparative |
|---|---|---|---|---|
| | 1 | 2 | Example 1 | Example 2 |
| Tapes | Fabric Tapes | | | |
| Slurry | Polycrystalline Diamond Slurry | | | |
| Processing | 1.5 | | | 5.5 |
| Load (lbs) | | | | |
| Rotational Speed | 597 | 883 | 1083 | 383 |
| of Disks (rpm) | | | | |

| | | |
|---|---|---|
| Oscillation | 7.8 | 5 |
| Frequency (Hz) | | |
| Oscillation | 1.0 | |
| Amplitude (mm) | | |

After texturing was finished, the glass disk was cleaned. In this manner, the glass substrate was obtained.

### EXAMPLE 2

### Example of Glass Substrate for Magnetic Disk

A glass substrate of Example 2 was prepared under texturing conditions that were different from those of Example 1 as shown in Table 1.

In Example 2, the texturing conditions were as described below. Fabric tapes were used as abrasive tapes, polycrystalline diamond slurry was used as a polisher (slurry), the glass disk was rotated at 883 revolutions per minute, the oscillation frequency of the glass disk was 7.8 Hz, the oscillation amplitude of the glass disk was 1 mm, and the processing load applied from pressing rollers was 3.675 kg (1.5 pounds).

### COMPARATIVE EXAMPLE 1

A glass substrate of Comparative Example 1 was prepared under texturing conditions that were different from those of Example 1 as shown in Table 1.

In Comparative Example 1, the texturing conditions were as described below. Fabric tapes were used as abrasive tapes, polycrystalline diamond slurry was used as a polisher (slurry), the glass disk was rotated at 1083 revolutions per minute, the oscillation frequency of the glass disk was 7.8 Hz, the oscillation amplitude of the glass disk was 1 mm, and the processing load applied from pressing rollers was 3.675 kg (1.5 pounds).

### COMPARATIVE EXAMPLE 2

A glass substrate of Comparative Example 2 was prepared under texturing conditions that were different from those of Example 1 as shown in Table 1.

The glass substrate of Comparative Example 2 is an example of a glass substrate for a magnetic disk with an outer diameter of 65 mm.

In Comparative Example 2, the texturing conditions were as described below. Fabric tapes were used as abrasive tapes, polycrystalline diamond slurry was used as a polisher (slurry), the glass disk was rotated at 383 revolutions per minute, the oscillation frequency of the glass disk was 5 Hz, the oscillation amplitude of the glass disk was 1 mm, and the processing load applied from pressing rollers was 13.475 kg (5.5 pounds).

[Measurement of Circumferential Arithmetic Average Roughness (Ra-c) of Principal Surfaces of Glass Substrates for Magnetic Disks, Ratio [Ra-c/Ra-r] of Circumferential Arithmetic Average Roughness (Ra-c) to Radial Arithmetic Average Roughness (Ra-r), and Crossing Angle of Texture Components]

Principal surfaces of the glass substrates, each of which was prepared in Example 1 or 2 or Comparative Example 1 or 2 as described above, were measured for circumferential arithmetic average roughness (Ra-c).

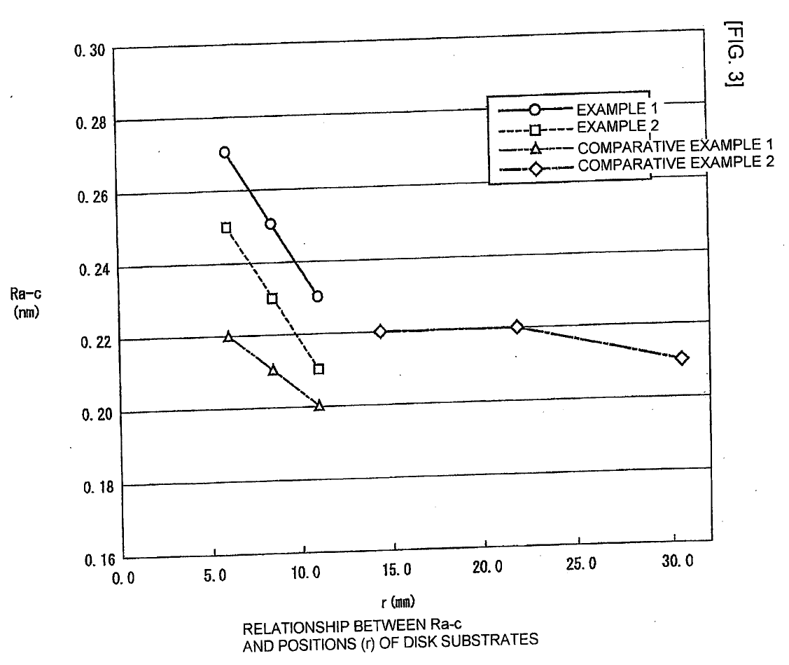

FIG. 3 is a graph showing the circumferential arithmetic average roughness (Ra-c) of measured regions of the principal surfaces of the glass substrates.

Table 2 describes the circumferential arithmetic average roughness (Ra-c) of the measured regions (located at a radius of 6, 8.5, or 11.0 mm from the center of each glass substrate) (for Comparative Example 2, the circumferential arithmetic average roughness of the measured regions located at a radius of 14.5, 22.0, or 30.6 mm from the center of the glass substrate is shown).

The glass substrates of Comparative Examples 1 and 2 are samples for comparison with the glass substrate described in Item 3, 5, or 8.

TABLE 2

| | Disk Substrate Size | | AFM | Arithmetic | Circumferential | Radial | | | |
|---|---|---|---|---|---|---|---|---|---|
| | Outer | Inner | Measurement | Average | Arithmetic | Arithmetic | | Crossing | L/UL |
| | Diameter | Diameter | Radius | Roughness | Average Roughness | Average Roughness | Ra-c/ | Angle | Durability |
| | [mm] | [mm] | r (mm) | Ra (mm) | Ra-c (mm) | Ra-r (mm) | Ra-r | (degree) | Test |
| Example 1 | 27.4 | 7.0 | 6.0 | 0.45 | 0.27 | 0.41 | 0.66 | 10.0 | 600000 |
| | | | 8.5 | 0.43 | 0.25 | 0.40 | 0.63 | 8.0 | Times Or |
| | | | 11.0 | 0.43 | 0.23 | 0.39 | 0.59 | 3.6 | More |
| Example 2 | 27.4 | 7.0 | 6.0 | 0.43 | 0.25 | 0.40 | 0.63 | 6.4 | 500000 |
| | | | 8.5 | 0.42 | 0.23 | 0.38 | 0.61 | 5.2 | Times |
| | | | 11.0 | 0.41 | 0.21 | 0.37 | 0.57 | 2.4 | |
| Comparative | 27.4 | 7.0 | 6.0 | 0.42 | 0.22 | 0.38 | 0.58 | 4.3 | 300000 |
| Example 1 | | | 8.5 | 0.42 | 0.21 | 0.38 | 0.55 | 2.8 | Times |
| | | | 11.0 | 0.41 | 0.20 | 0.37 | 0.54 | 2.2 | |
| Comparative | 65.0 | 20.0 | 14.5 | 0.44 | 0.22 | 0.39 | 0.56 | 3.6 | 600000 |
| Example 2 | | | 22.0 | 0.44 | 0.22 | 0.39 | 0.56 | 3 | Times Or |
| | | | 30.6 | 0.43 | 0.21 | 0.38 | 0.55 | 2.6 | More |

As is clear from FIG. 3 and Table 2, the circumferential roughness of the principal surface of the glass substrate of each example increases continuously from an outer circumferential section toward an inner circumferential section of the principal surface.

In the glass substrates of the examples, the measured region located at a radius of 6 mm from the center of each glass substrate has a circumferential arithmetic average roughness (Ra-c) of 0.25 nm or more and the measured region located at a radius of 11 mm from the center of the glass substrate has a circumferential arithmetic average roughness (Ra-c) of 0.24 nm or less.

For the glass substrates of Examples 1 and 2 and Comparative Examples 1 and 2, the ratio [Ra-c/Ra-r] of the circumferential arithmetic average roughness (Ra-c) to the radial arithmetic average roughness (Ra-r) of each principal surface was determined.

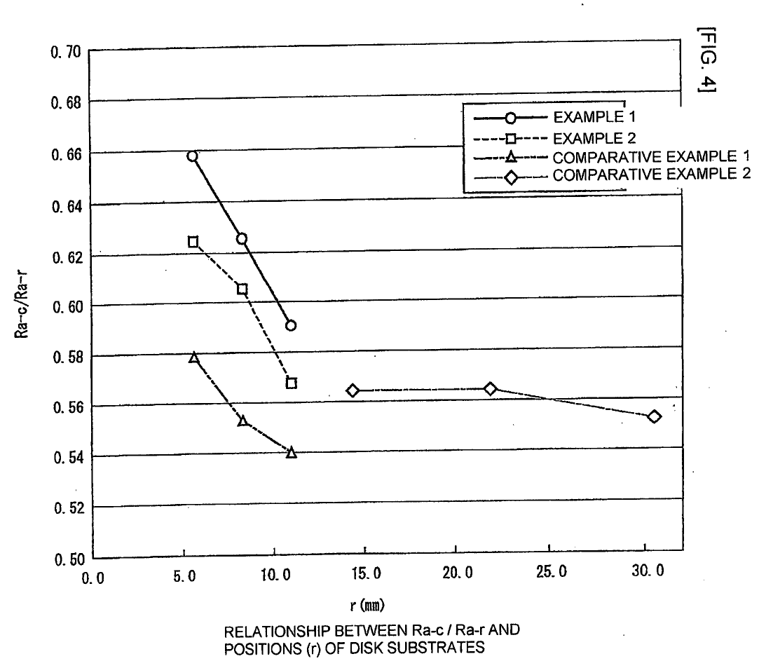

FIG. 4 is a graph showing the ratio [Ra-c/Ra-r] of the circumferential arithmetic average roughness (Ra-c) to the radial arithmetic average roughness (Ra-r) of the principal surface.

Table 2 describes the ratio [Ra-c/Ra-r] of the circumferential arithmetic average roughness (Ra-c) to the radial arithmetic average roughness (Ra-r) of the principal surface.

As is clear from FIG. 4 and Table 2, in the principal surfaces of the glass substrates of the examples, the circumferential roughness is less than the radial roughness.

The ratio [Ra-c/Ra-r] of the circumferential arithmetic average roughness (Ra-c) to the radial arithmetic average roughness (Ra-r) increases from the outer circumferential section toward the inner circumferential section of each principal surface.

In the measured region located at a radius of 6 mm from the center of the glass substrate of each example, the ratio [Ra-c/Ra-r] of the circumferential arithmetic average roughness (Ra-c) to the radial arithmetic average roughness (Ra-r) is 0.61 or more. In the measured region located at a radius of 11 mm from the center of the glass substrate of each example, the ratio [Ra-c/Ra-r] of the circumferential arithmetic average roughness (Ra-c) to the radial arithmetic average roughness (Ra-r) is 0.60 or less.

In the principal surfaces of the glass substrates prepared in the examples as described above, 5-μm square regions were measured by atomic force microscopy. The obtained measurements were Fourier-transformed by two-dimensional FFT.

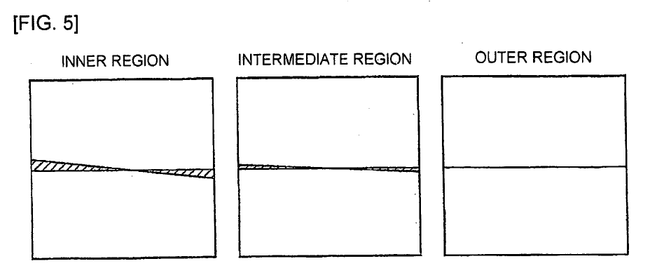

FIG. 5 shows images obtained by Fourier-transforming the measurements of the regions measured by atomic force microscopy.

The angle (crossing angle) between texture components crossing each other as shown in FIG. 5 was determined. The texture components extended in the circumferential direction of the glass substrates.

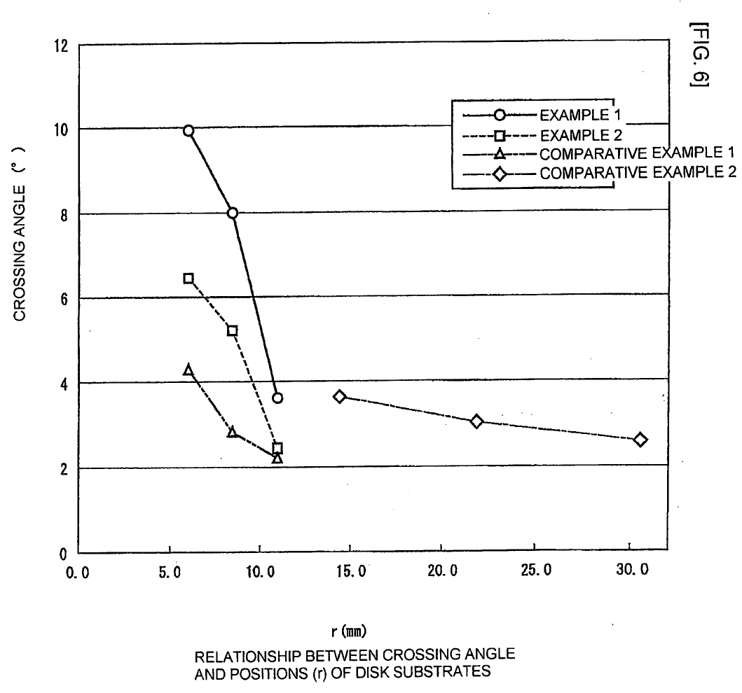

FIG. 6 is a graph showing the crossing angle between the texture components present in the measured regions of the principal surfaces of the glass substrates of the examples and the comparative examples.

Table 2 describes the crossing angle between the texture components present in the measured regions of the principal surfaces of the glass substrates of Example 1 and 2 and Comparative Examples 1 and 2.

FIG. 6 illustrates that the crossing angle increases from the outer circumferential section toward the inner circumferential section of each principal surface. That is, tan θ is inversely proportional to r (that is, tan θ is proportional to 1/r), when θ represents the crossing angle and r represents the distance from the center of each glass substrate.

In the glass substrates of the examples, the angle (crossing angle) between the texture components present in the measured region located at a radius of 6 mm from the center of each glass substrate is 5.0 degrees or more and the angle (crossing angle) between the texture components present in the measured region located at a radius of 11 mm from the center of each glass substrate is 4.5 degrees or less.

### EXAMPLE 3

### Example of Magnetic Disk

Magnetic disks according to the present invention were manufactured according to steps below.

The following layers were formed on the principal surfaces of the glass substrates of Examples 1 and 2 in this order with an opposite target-type DC magnetron sputtering system: seed layers made of an Al—Ru alloy, base layers made of a Cr—W alloy, magnetic layers made of a Co—Cr—Pt—Ta alloy, and protective layers made of carbon hydride. The seed layers have a function of refining magnetic grains contained in the magnetic layers and the base layers have a function of aligning the easy axes of the magnetic layers in the in-plane direction.

The magnetic disks include the glass substrates that are non-magnetic, the magnetic layers disposed above the glass substrates, the protective layers disposed on the magnetic layers, and lubricating layers disposed on the protective layers.

The seed layers and base layers disposed between the glass substrates and the magnetic layers form non-magnetic metal layers (non-magnetic base layers). In the magnetic disks, all the layers other than the magnetic layers are non-magnetic. In this example, the magnetic layers are in contact with the protective layers and the protective layers are in contact with the lubricating layers.

The seed layers were formed on the respective glass substrates by sputtering using a target made of an Al—Ru (aluminum-ruthenium) alloy (50 atomic percent Al and 50 atomic percent Ru) so as to have a thickness of 30 nm. The base layers were formed on the respective seed layers 5 by sputtering using a target made of a Cr—W (chromium-tungsten) alloy (80 atomic percent Cr and 20 atomic percent W) so as to have a thickness of 20 nm. The magnetic layers were formed on the respective base layers by sputtering using a target made of a Co—Cr—Pt—Ta (cobalt-chromium-platinum-tantalum) alloy (20 atomic percent Cr, 12 atomic percent Pt, and 5 atomic percent Ta, the remainder being Co) so as to have a thickness of 15 nm.

The protective layers were formed on the respective magnetic layers and the lubricating layers made of PFPE (perfluoroalkylpolyether) were formed on the respective protective layers by a dipping process. The protective layers had a function of protecting the magnetic layers from the impact arising from a magnetic head. The magnetic disks were prepared as described above.

The obtained magnetic disks were subjected to a glide test using a glide head of which the flying height was 10 nm. The test showed that the magnetic disks had no colliding objects and the flying behavior of the glide head was maintained stable. The magnetic disks were subjected to a recording/reproducing test at 700 kFCI. This test showed that sufficient signal-to-noise ratios (S/N ratios) were obtained from the magnetic disks. Furthermore, no signal errors were observed.

The magnetic disks were each installed in a “1-inch hard disk drive” for recording data at a density of 60 Gbit or more per square inch. The operation of the drive showed that data was recorded on or reproduced from the magnetic disks without any problems. That is, no crash or thermal asperity occurred.

The glass substrates of Comparative Examples 1 and 2 were used to manufacture magnetic disks similar to those manufactured in Example 3.

The following disks were tested for load/unload durability: the magnetic disks manufactured from the glass substrates of Examples 1 and 2 and the magnetic disks manufactured from the glass substrates of Comparative Examples 1 and 2. The results of this test are shown in Table 2.

The number of times the magnetic disk manufactured from the glass substrate of Example 1 passed the test of load/unload durability is six hundred thousand or more. This shows that this magnetic disk has sufficient durability.

The number of times the magnetic disk manufactured from the glass substrate of Example 2 passed the test of load/unload durability is five hundred thousand. This shows that this magnetic disk has sufficient durability.

The number of times the magnetic disk manufactured from the glass substrate of Comparative Example 1 passed the test of load/unload durability is three hundred thousand or more. This shows that this magnetic disk has insufficient durability.

The number of times the magnetic disk manufactured from the glass substrate of Comparative Example 2 passed the test of load/unload durability is six hundred thousand or more. Although this magnetic disk has sufficient durability, it is meaningless to compare this magnetic disk with the other magnetic disks having an outer diameter of 27.4 mm. This is because this magnetic disk has an outer diameter of 65 mm and regions measured for surface roughness are 14.5, 22.0, or 30.6 mm apart from the center of this magnetic disk.

### SECOND EXAMPLE

A second example of the present invention will now be described.

In the second example, a substrate for manufacturing a magnetic disk was used. The substrate had a diameter less than those of the glass substrates used in the first example. A method for manufacturing the substrate, a method for texturing the substrate, and a method for manufacturing the magnetic disk are substantially the same as those described in the first example.

Table 3 summarizes the arithmetic average roughness (Ra) of measured regions of the substrate, the arithmetic average roughness (Ra) of measured regions of the magnetic disk, and TOP of the measured regions of the substrate and the magnetic disk. The measured regions are located at different radii from the center of the substrate or the magnetic disk. Furthermore, Table 3 summarizes TOP of substrates and magnetic disks of Comparative Examples 3 and 4 for comparison. These substrates and magnetic disks are different in surface roughness from each other. In Table 3, a TOP of 0.91 atm corresponds to atmospheric pressure at a measured region.

TABLE 3

| | Disk Substrate Size | | AFM | Arithmetic | Arithmetic | |
|---|---|---|---|---|---|---|
| | Outer | Inner | Measurement | Average Roughness | Average Roughness | Take-off |
| | Diameter | Diameter | Radius | of SUB | of Media | Pressure |
| | (mm) | (mm) | r (mm) | Ra (nm) | Ra (nm) | (atm) |
| Example 3 | 21.6 | 6.0 | 5.0 | 0.71 | 0.64 | 0.86 |
| | | | 7.0 | 0.63 | 0.60 | 0.84 |
| | | | 9.0 | 0.62 | 0.59 | 0.82 |
| Comparative | 21.6 | 6.0 | 5.0 | 0.64 | 0.50 | 0.91 |
| Example 3 | | | 7.0 | 0.54 | 0.48 | 0.91 |
| | | | 9.0 | 0.52 | 0.43 | 0.91 |
| Comparative | 21.6 | 6.0 | 5.0 | 0.61 | 0.51 | 0.91 |
| Example 4 | | | 7.0 | 0.62 | 0.55 | 0.84 |
| | | | 9.0 | 0.60 | 0.50 | 0.84 |

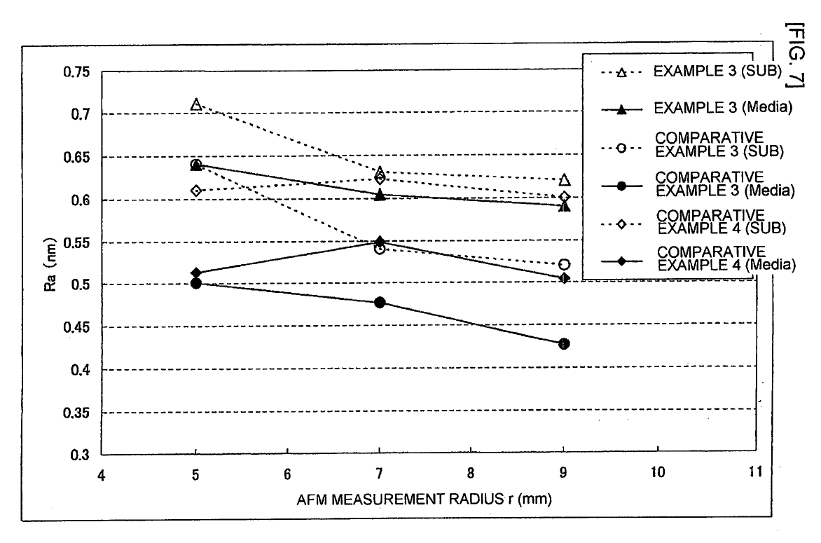

FIG. 7 is a graph showing the roughness in Table 3. That is, FIG. 7 shows the roughness of the substrate and magnetic disk of Example 3, that of the substrate and magnetic disk of Comparative Example 3, and that of the substrate and magnetic disk of Comparative Example 4. The surface roughness was determined by atomic force microscopy as described above. FIG. 7 illustrates that the roughness of each magnetic disk depends on the roughness of the substrate used to manufacture the magnetic disk. Specifically, an increase in substrate roughness leads to an increase in magnetic disk roughness. In Example 3, the roughness of a measured region (first region) located at a first radius from the center of the substrate or the magnetic disk is less than that of a measured region (second region) located at a second radius from the center of the substrate. The second radius is less than the first radius. The first region may be a region which can be brought in contact with a magnetic head at the start of rotation, recording, or reproducing or a region to which a magnetic head in an LUL system is guided. A region inner than this region has a surface roughness greater than that of this regions. The surface roughness may increase from this region toward the inner region stepwise or continuously.

TDP (touch-down pressure) and TOP (take-off pressure) will now be described. There is apprehension that the frequency of contacts between magnetic heads and magnetic disks increases because a recent increase in the storage density of the magnetic disks causes a reduction in the flying height of the magnetic heads. In order to evaluate flying properties, TDP and TOP are measured.

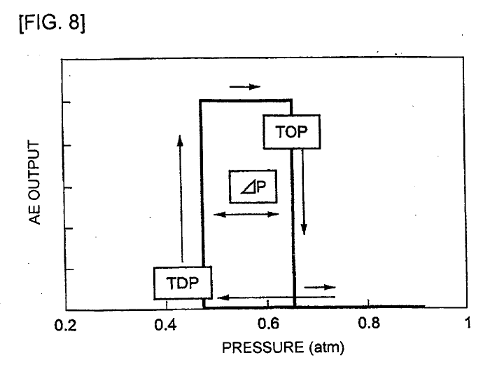

FIG. 8 is a conceptual view sowing a TDP/TOP test. The TDP (touch-down pressure) is defined as a pressure at which a magnetic head in flying is caused to slide by gradually reducing the pressure in a hard disk drive. The TOP (take-off pressure), in contrast to the TDP, is defined as a pressure at which the magnetic head in sliding is caused to fly by gradually increasing the pressure in the hard disk drive. The transition from flying to sliding, namely, the contact between the magnetic disk and the magnetic head can be detected by checking the output of an AE (acoustic emission) sensor. This test is carried out in a vessel in which the pressure can be controlled.

The measurement of the TDP is effective in evaluating the ability of the magnetic head to avoid contacting the magnetic disk. The measurement of the TOP is effective in evaluating the ability of the magnetic head to take off from the magnetic disk. Therefore, the TDP and the TOP are preferably both small and the difference AP between the TDP and the TOP is preferably small. The fact that the difference AP therebetween is small means that the magnetic head has excellent flying properties.

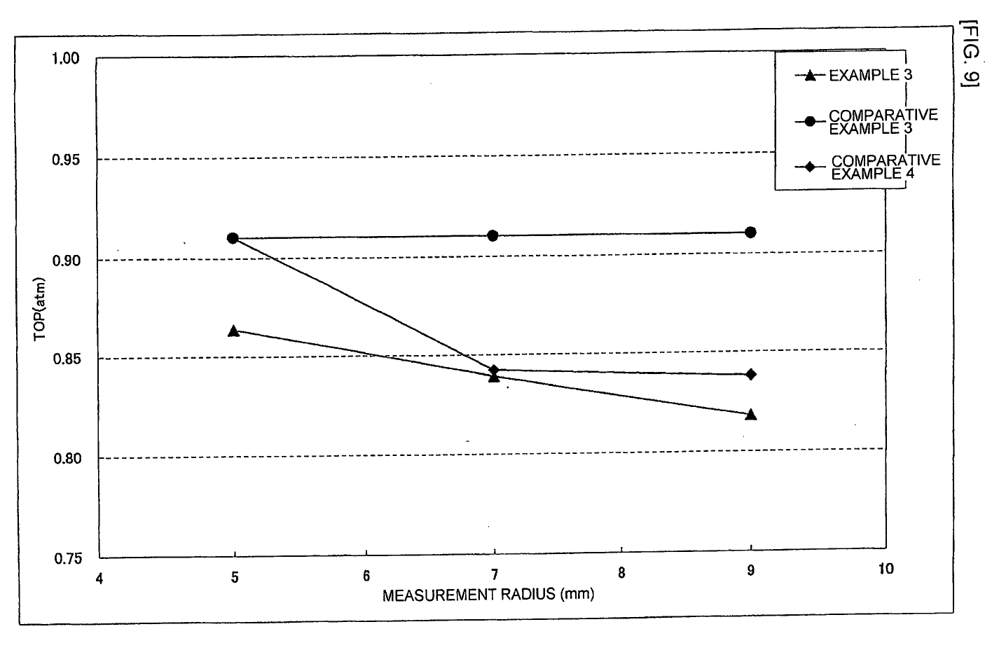

FIG. 9 is a graph obtained by plotting the TOP shown in Table 3, that is, a graph obtained by plotting the TOP versus the radius measured in Example 3 and Comparative Examples 3 and 4. Since Comparative Example 3 is less in roughness than Example 3, the TOP measured in Comparative Example 3 is substantially equal to atmospheric pressure. In Comparative Example 4, the roughness of the principal surface is uniform in the radial direction. Therefore, the TOP measured in Comparative Example 4 is greater than that measured in Example 3. In particular, since the roughness of a region close to an ID side is small, the TOP is substantially equal to atmospheric pressure.

The reason why the TOP measured at a region close to an ID side of each magnetic disk is high is probably as follows: since the relative linear velocity between a magnetic head and an inner circumferential section of the magnetic disk, which has a small diameter, is low, the magnetic head cannot achieve sufficient lift and therefore flies unstably. The TOP may be improved by increasing the roughness of the magnetic disk and that of the magnetic head. For example, the roughness of the magnetic head may be increased. In this case, the magnetic head preferably has a roughness greater than any regions of the magnetic disk.

In a magnetic recording apparatus including a driving part for driving a magnetic disk in a recording direction, a magnetic head including a reproducing part and a recording part, and a unit for moving this magnetic head relatively to this magnetic disk, this magnetic head is preferably an NPAB slider. This prevents this magnetic head from contacting or sliding on this magnetic disk. Even if this magnetic head contacts or slides on this magnetic disk, this magnetic head can readily take off. A combination of these components is effective in enhancing flying properties of the magnetic head.

In the present invention, the diameter (size) of a glass substrate for a magnetic disk is not particularly limited. The present invention is particularly suitable for manufacturing a glass substrate for a compact magnetic disk. Such a compact magnetic disk used herein is defined as a magnetic disk with a diameter of 30 mm or less.

### INDUSTRIAL APPLICABILITY

The present invention can be applied to compact hard disk drives that can be installed in portable or vehicle-mounted apparatuses such as mobile phones, digital cameras, PDAs, and car navigation systems.

1. A glass substrate for a magnetic disk installed in a hard disk drive, wherein:
a circumferential roughness on a principal surface in a circumferential direction of the glass substrate increases from an outer circumferential section toward an inner circumferential section of the principal surface.

2. The glass substrate according to claim 1, wherein:
the circumferential roughness of the principal surface increases continuously from the outer circumferential section toward the inner circumferential section.

3. The glass substrate according to claim 1, wherein:
the principal surface has a region which is located at a radius of 6 mm from a center of the glass substrate and which has a circumferential arithmetic average roughness of 0.25 nm or more, and
the principal surface has a region which is located at a radius of 11 mm from the center of the glass substrate and which has a circumferential arithmetic average roughness of 0.24 nm or less.

4. The glass substrate according to claim 1, wherein:
the ratio of the circumferential roughness to a radial roughness of the principal surface in a radical direction increases from the outer circumferential section toward the inner circumferential section.

5. The glass substrate according to claim 1, wherein:
a ratio of a circumferential arithmetic average roughness to a radial arithmetic average roughness of a region of the principal surface which is located at a radius of 6 mm from a center of the glass substrate is 0.61 or more, and
a ratio of the circumferential arithmetic average roughness to the radial arithmetic average roughness of a region of the principal surface which is located at a radius of 11 mm from the center of the glass substrate is 0.60 or less.

6. A glass substrate for a magnetic disk installed in a hard disk drive, wherein:
a principal surface has a texture including components crossing each other and extending in a circumferential direction of the glass substrate, and
a crossing angle between the texture components increases from an outer circumferential section toward an inner circumferential section of the principal surface.

7. The glass substrate according to claim 6, wherein:
the crossing angle between the texture components increases continuously from the outer circumferential section toward the inner circumferential section.

8. The glass substrate according to claim 6, wherein:
the crossing angle between the texture components present in a region of the principal surface which is located at a radius of 6 mm from a center of the glass substrate is 5.0 degrees or more, and
the crossing angle between the texture components present in a region of the principal surface which is located at a radius of 11 mm from the center of the glass substrate is 4.5 degrees or less.

9. The glass substrate according to claim 1, wherein:
the principal surface is processed so as to have a magnetic layer formed thereon, whereby the glass substrate is converted into the magnetic disk, and
the texture of the principal surface imparts magnetic anisotropy to the magnetic layer.

10. The glass substrate according to claim 1, wherein:
the magnetic disk is installed in a 1-inch hard disk drive or a hard disk drive smaller than such a 1-inch hard disk drive.

11. The glass substrate according to claim 1, wherein:
the magnetic disk is installed in a hard disk drive which is started and stopped by a load/unload system.

12. A disk-shaped glass substrate for a magnetic disk, comprising:
a principal surface having a first region and a second region with a roughness greater than that of the first region,
wherein the first region is located outside the second region.

13. The glass substrate according to claim 12, wherein:
the first region is used to guide a magnetic head to the magnetic disk.

14. A magnetic disk, comprising:
the glass substrate according to claim 1,
wherein the glass substrate has at least one magnetic layer disposed thereon.

15. The magnetic disk according to claim 14, wherein:
the principal surface has a region with a roughness less than the surface roughness of a magnetic head to be used.

16. The glass substrate according to claim 6, wherein:
the principal surface is processed so as to have a magnetic layer formed thereon, whereby the glass substrate is converted into the magnetic disk, and the texture of the principal surface imparts magnetic anisotropy to the magnetic layer.

17. The glass substrate according to claim 6, wherein:
the magnetic disk is installed in a 1-inch hard disk drive or a hard disk drive smaller than such a 1-inch hard disk drive.

18. The glass substrate according to claim 6, wherein:
the magnetic disk is installed in a hard disk drive which is started and stopped by a load/unload system.

19. A magnetic disk, comprising:
the glass substrate according to claim 6,
wherein the glass substrate has at least one magnetic layer disposed thereon.

20. A magnetic disk, comprising:
the glass substrate according to claim 12,
wherein the glass substrate has at least one magnetic layer disposed thereon.
